(19) United States
(12) Patent Application Publication
(10) Pub. No.: US 2014/0050927 A1
(43) Pub. Date: Feb. 20, 2014

(54) BASE COATS FOR OVERBAKED MULTI-LAYER COATINGS

(71) Applicant: Bernhard Steinmetz, Rutschenhausen (DE)

(72) Inventor: Bernhard Steinmetz, Rutschenhausen (DE)

(73) Assignee: BASF COATINGS GMBH, Munster (DE)

(21) Appl. No.: 13/980,818

(22) PCT Filed: Jan. 24, 2012
(86) PCT No.: PCT/EP2012/051032

§ 371 Date: Sep. 30, 2013

Related U.S. Application Data
(60) Provisional application No. 61/435,842, filed on Jan. 25, 2011.

(30) Foreign Application Priority Data
Jan. 25, 2011 (EP) 11152122.5

(51) Int. Cl. C09D 7/12

(52) U.S. Cl. CPC C09D 7/1233
USPC 428/425.9; 524/162; 524/158; 524/159; 427/407.1

(57) ABSTRACT

A thermally curable basecoat material comprising at least one polyurethane resin as binder, at least one pigment, 30% to 70% by weight of water, based on the total weight of the basecoat material, and 0.04% to 2.3% by weight, based on the total weight of the basecoat material, of at least one disulfonic acid compound of formula (I). The basecoat material is applied to an overbaked multicoat paint system, and has outstanding adhesion properties.

### FIELD OF THE INVENTION

The present invention relates to thermally curable basecoat materials, their preparation and use and also to multicoat and dual paint systems comprising the basecoat materials, to methods for producing them, and to the use thereof. The invention further relates to substrates coated with the basecoat materials or with the multicoat and dual paint systems.

### PRIOR ART

Multicoat paint systems used in the automotive OEM finishing segment nowadays consist in general of an electrophoretically applied primer, which protects against corrosion and stone chipping, and a subsequent primer-surfacer coat, which protects against stone chipping and smoothens the surface. The primer-surfacer coat in this system is usually applied to the already baked primer, and cured. An alternative possibility is to cure primer and primer-surfacer coat jointly. Applied subsequently to the cured primer-surfacer coat is a single-coat finish or a decorative two-coat finish composed of a color and/or effect basecoat film, which is applied in one or more spray passes depending on the particular shade, and a protective clearcoat film, which is applied wet-on-wet to the basecoat film. Subsequently the single-coat finish or the basecoat film(s) and the clearcoat film is or are jointly cured.

“Wet-on-wet finishing” is a term for dual or multiple painting without intermediate drying (Römpp Lacke und Druckfarben, Georg Thieme Verlag Stuttgart/New York 1998, ISBN 3-13-776001-1, entry heading “wet-on-wet finishing”).

Wet-on-wet finishes and corresponding methods are known from, for example, German patent application DE 199 48 004 A1 (page 17, line 37, to page 19, line 22), or from German patent DE 100 43 405 C1 (column 3, paragraph [0018], and column 8, paragraph [0052], to column 9, paragraph [0057], in conjunction with column 6, paragraph [0039], to column 8, paragraph [0050]). They are used not only for the OEM (production-line) finishing but also for the refinish of automobile bodies.

In the course of the thermal cure during the coating operation in OEM finishing, overbaking of the basecoat and/or clearcoat films may occur. Overbaking is a term for the baking of a coating material with an energy supply which is higher (baking time and/or baking temperature are exceeded) than is necessary for complete crosslinking (Römpp Lexikon Lacke und Druckfarben, page 585, entry heading “overbaking”). If, however, no additional finishing defects such as leveling disruptions or drying disruptions occur, then the finish is generally released (cf. Römpp Lexikon Lacke and Druckfarben, ISBN 3-13-776001-1, entry heading “painting defects”).

If the finish has been overbaked and in addition has finishing defects, then the overbaked multicoat paint system comprising basecoat and clearcoat is optionally sanded in those areas where the finishing defects have appeared, and the body is introduced anew into the finishing operation. In this operation, again, basecoat and clearcoat materials are applied, dried and cured (the resultant coats are referred to below as “additional basecoat” and “additional clearcoat”, respectively). The overall paint system made up of overbaked multicoat paint system and additional basecoat and clearcoat is called a “dual finish”.

If the clearcoat in the first finishing operation is overbaked, however, there is a reduction in the adhesion of an additional basecoat applied over it. Especially since the inception of highly scratch-resistant clearcoats, adhesion properties between the overbaked multicoat paint system and the additional basecoat film may be inadequate. This phenomenon occurs especially if the overbaked multicoat paint system is not sanded before the dual finish is applied.

### PROBLEM

The problem on which the present invention was based, therefore, is that of eliminating the above-described disadvantages of the prior art. The intention was to provide thermally curable basecoat materials which, as an additional basecoat film in a dual finish, especially on overbaked multicoat paint systems, exhibit significantly improved adhesion properties in comparison with prior-art basecoat materials. The basecoat materials ought additionally to be suitable for use both as an additional basecoat material and as a basecoat material of the overbaked multicoat paint system. This would have the advantage that, for the finishing operation, even in the case of overbaking, it would be necessary to provide only one single basecoat material.

The term “thermal curing” denotes the heat-initiated crosslinking of a coating film.

“Basecoat” is a term for a color-imparting intermediate coating material which is customary in automobile finishing. The resultant basecoat is part of a multicoat paint system which additionally comprises a topmost clearcoat, which protects the basecoat from effects of weathering, mechanical attack and chemical attack (Römpp Lacke and Druckfarben, Georg Thieme Verlag Stuttgart/New York 1998, ISBN 3-13-776001-1, entry heading “basecoat”). In a multicoat paint system there may also be two or more basecoats arranged over one another.

### SOLUTION

Surprisingly, basecoat materials have been found which do not have the disadvantages of the prior art. Basecoat materials have been found which, in a dual paint system, as additional basecoats on overbaked multicoat paint systems, exhibit outstanding adhesion. Moreover, it has been possible to use the basecoat material in the overbaked multicoat paint system. Accordingly, thermally curable basecoat materials have been found which comprise
a. at least one polyurethane resin as binder,
b. at least one pigment,
c. 30% to 70% by weight of water, based on the total weight of the basecoat material, and
d. 0.04% to 2.3% by weight, based on the total weight of the basecoat material, of at least one compound of the formula (I)

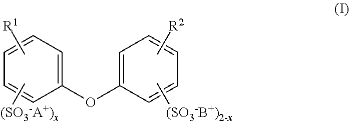

in which
R¹ and R² are hydrogen atoms or linear or branched alkyl radicals having 4 to 24 carbon atoms, it being possible for R¹ and R² to be identical or different,
A and B independently of one another are H, an alkali metal or NH₄, and
x is 1 or 2.

The basecoat materials identified above are also referred to below as basecoat materials of the invention. The weight fractions of all of the constituents of the basecoat material of the invention add up to 100% by weight.

European application EP 0603659A1 and U.S. Pat. No. 4,971,841 disclose basecoat and clearcoat materials which comprise sulfonic acid derivatives as curing catalysts. Suitability is possessed by, for example, p-toluenesulfonic acid, dinonylnaphthalenedisulfonic acid or dodecylbenzenesulfonic acid. On overbaked clearcoats, however, these coating materials do not exhibit sufficient adhesion.

### Binders

Binders for the purposes of the present invention are self-crosslinking and externally crosslinking binders.

In the case of externally crosslinking binders, a separate crosslinking agent is used. In the case of self-crosslinking binders, separate crosslinking agents are unnecessary. The crosslinking agent comprises reactive functional groups which are complementary to the reactive functional groups present in the binders. If the complementary reactive functional groups or autoreactive functional groups, i.e. groups which react “with themselves”, are already present in the binder molecules, the resultant binders are self-crosslinking. Examples of suitable complementary reactive functional groups and autoreactive functional groups are known from German patent application DE 199 30 665 A1, page 7, line 28, to page 9, line 24.

The basecoat material of the invention comprises at least one saturated or unsaturated polyurethane resin as binder. Suitable saturated or unsaturated polyurethane resins are described in, for example,
German patent application DE 199 11 498 A1, column 1, lines 29 to 49, and column 4, line 23, to column 11, line 5,
German patent application DE 199 48 004 A1, page 4, line 19, to page 13, line 48,
European patent application EP 0 228 003 A1, page 3, line 24, to page 5, line 40,
European patent application EP 0 634 431 A1, page 3, line 38, to page 8, line 9, or
international patent application WO 92/15405, page 2, line 35, to page 10, line 32.

Polyurethane resins for stabilization comprise preferably alternatively
functional groups which can be converted into cations by neutralizing agents and/or quaternizing agents, and/or cationic groups, or
functional groups which can be converted into anions by neutralizing agents, and/or anionic groups, or
nonionic hydrophilic groups.

Preference is given here to carboxyl or carboxylate groups and also to nucleophilic groups such as amine groups or hydroxyl groups.

Suitable crosslinking agents are, for example, polyisocyanates, containing blocked or nonblocked NCO groups, and amino resins such as melamine-formaldehyde resins.

The polyurethane resins are linear of contain branches. They may also take the form of graft polymers. In that case they are grafted preferably with acrylates groups. The corresponding acrylate groups are introduced into the polymer preferably after a polyurethane primary dispersion has been prepared. Graft polymers of this kind are well known to the skilled person and are described in DE 199 48 004 A1, for example.

If the binders take the form of self-crosslinking systems, then the polyurethane resin content is preferably 50% to 100% by weight, more preferably 50% to 90% by weight, and very preferably 50%, preferably 80%, by weight, based on the film-forming solids of the basecoat material.

By film-forming solids is meant the nonvolatile weight fraction of the coating material without pigments, fillers and the compound of formula (I). This FIGURE has been determined in accordance with DIN EN ISO 3251. The measuring time was 60 minutes at 125° C.

In the case of externally crosslinking systems, the polyurethane resin content is preferably between 10% and 80% by weight, more preferably between 15% and 75% by weight, and with particular preference between 20% and 70% by weight, based in each case on the film-forming solids of the basecoat material.

It is preferred to use externally crosslinking binders.

The basecoat material may further comprise polyacrylates and/or polyesters as further externally crosslinking or self-crosslinking binders. Such binders comprise at least one reactive functional group, which is described in DE 199 30 665 A1 (see above).

Polyurethane resins which contain acrylate groups are also referred to as polyurethane acrylates. They are preferred binders of the basecoat material of the invention.

### Disulfonates

The compound of formula (I) is included in a fraction of 0.04% to 2.30% by weight, preferably 0.04% to 1.60% by weight, based on the total weight of the basecoat material of the invention. With particular preference the fraction is 0.04% to 1.20% by weight.

If the amount of the compound (I) is below 0.04% by weight, the problem addressed by the invention is not solved. If the amount is more than 2.3% by weight, there are certain circumstances in which disadvantages must be accepted, such as a deterioration in the properties of the paint finishes following condensation exposure, for example.

Preferably at least one of the radicals R¹ and R² is an alkyl radical. More preferably precisely one radical, R¹ or R², more preferably R¹, is an alkyl radical. With particular preference R¹ is an alkyl radical and R²=H.

Preferred alkyl radicals are linear or branched with 6 to 18 carbon atoms, more preferably 6, 12 or 16 carbon atoms, very preferably 12 carbon atoms. The alkyl radicals are preferably branched.

As compounds of the formula (I) it is possible to use compounds in which the variable x is 1 or 2. Furthermore, mixtures with x=1 and x=2 may also be employed.

In one preferred embodiment, A and B are hydrogen atoms, alkali metals or NH₄. Particularly preferred alkali metals are Na and K. With very particular preference, A=B=Na.

Particularly preferred disulfonates are available, for example, in the form of an aqueous solution under the trade name Dowfax 2A1 from the Dow Chemical Company.

### Pigments

The basecoat materials of the invention comprise at least one pigment. Preferably the basecoat materials comprise 0.5% to 20% by weight, based on the total weight of the basecoat material, of at least one pigment. More preferred basecoat materials are those which comprise 2% to 10% by weight of pigments.

Pigments are colorants in powder or platelet form which in contrast to dyes are insoluble in the surrounding medium (cf. Römpp Lacke and Druckfarben, Georg Thieme Verlag Stuttgart/New York 1998, ISBN 3-13-776001-1, entry heading “pigments”).

The pigment is preferably selected from the group consisting of organic and inorganic, color, effect, color and effect, magnetically shielding, electrically conductive, anticorrosion, fluorescent and phos-phorescent pigments. Preferred pigments are color and/or effect pigments.

### Organic Solvents

The basecoat materials of the invention may comprise organic solvents. Preferably a maximum of 15% by weight of organic solvents is included, based on the total weight of the basecoat material. This is a specification value in the automobile industry for the fraction of volatile organic compounds which ought not to be exceeded.

### Water

The basecoat materials comprise 30% to 70% by weight of water based on the total weight of the basecoat materials. Preferably there is 35% to 65% by weight of water included. Basecoat materials of this kind are frequently referred to in the art as waterborne or aqueous coating materials.

### Catalysts

The basecoat materials of the invention may comprise catalysts for the crosslinking reaction of the reactive functional groups of the binders and any crosslinking agents present that are different from the compounds of the formula (I). The basecoat materials may comprise 0.05% to 2% by weight, based on the total weight of the basecoat material, of at least one catalyst. Suitable catalysts are, for example sulfonic or phosphonic acid derivatives.

### Auxiliaries and Additives

The basecoat materials of the invention may comprise auxiliaries and additives which are different from the substances identified above. The basecoat materials preferably comprise 2% to 10% by weight, based on the total weight of the basecoat material, of at least one auxiliary or additive.

Suitable auxiliaries or additives are the known auxiliaries and additives used typically in the coatings industry.

Examples of suitable auxiliaries and additives are, for example, antioxidants, deaerating agents, wetting agents, dispersants, emulsifiers, rheological assistants such as flow control agents, thickeners, film-forming assistants, anti-sag agents, and thixotropic agents, waxes and wax-like compounds, slip additives, reactive diluents, fillers, dyes, nanoparticles, free-flow aids, siccatives, biocides, substrate wetting improver additives, surface smoothness improver additives, sag control agents (SCAB), matting or flatting agents, free-radical scavengers, light stabilizers, adhesion promoters, corrosion inhibitors, free-radical polymerization initiators, flame retardants or polymerization inhibitors, as described in detail in the book “Lackadditive” by Johan Bieleman, Wiley-VCH, Weinheim, N.Y., 1998.

Suitable additives of the type identified above are known from, for example, German patent application DE 199 48 004 A1, page 14, line 4, to page 17, line 5, and from German patent DE 100 43 405 C1, column 5, paragraph [0031] to [0033].

### Inventive Basecoat Materials

The solids content of the basecoat material of the invention may vary according to the requirements of the case in hand. Primarily the solids content is guided by the viscosity that is required for application, more particularly spray application, and so may be adjusted by the skilled person on the basis of his or her general art knowledge, where appropriate with the assistance of a few range finding tests.

The solids content of the basecoat materials of the invention is preferably 5% to 70%, more preferably 10% to 65%, and more particularly 12% to 60% by weight, based in each case on the total weight of the basecoat material.

By solids content is meant the weight fraction which remains as a residue on evaporation under defined conditions. This fraction has been determined in accordance with DIN EN ISO 3251. The measurement duration was 60 minutes at 125° C.

The basecoat materials are thermally curable. In addition they may be cured with actinic radiation. The basecoat materials may, furthermore, comprise binders which can be cured physically.

In the context of the present invention, the term “physical curing” denotes the formation of a film by loss of solvents (particularly organic solvents and water) from polymer solutions or polymer dispersions. Typically no crosslinking agents are needed for such curing.

In the context of the present invention, “actinic radiation” means electromagnetic radiation such as near infrared (NIR), visible light, UV radiation, X-radiation or gamma radiation, more particularly UV radiation, and particulate radiation such as electron beams, beta radiation, alpha radiation, proton beams or neutron beams, more particularly electron beams. Where thermal curing and curing with actinic radiation are employed jointly, the term “dual cure” is also used.

The basecoat materials of the invention may be employed as one-component (1K) two-component (2K) or multicomponent systems.

In one-component systems, binder and crosslinking agent are present alongside one another, i.e. in one component. A precondition for this is that the two constituents crosslink with one another only at relatively high temperatures and/or on exposure to actinic radiation. Examples of suitable crosslinking agents include blocked polyisocyanates.

In two-component and multicomponent systems, binder and crosslinking agent are present separately from one another in at least two components which are not combined until shortly or immediately before application, in other words within the processing life. This form is selected when binder and crosslinking agent react with one another even at room temperature (20 to 25° C.). Suitable crosslinking agents include, for example, non-blocked polyisocyanates.

One particularly preferred embodiment of the invention is a basecoat material which comprises a mixture of a polyurethane acrylate and a polyester as binder, a melamine-formaldehyde resin as crosslinking agent, 0.04% to 1.20% by weight of at least one compound of formula (I) with R²=H and A=B=Na, 35% to 65% by weight of water, and 2% to 10% by weight of pigments, based in each case on the total weight of the basecoat material.

### Further Subjects of the Invention

The basecoat materials of the invention are prepared preferably by the method of the invention for producing the basecoat material of the invention.

Accordingly, a method for producing the basecoat material of the invention is a further subject of the present invention. The basecoat material in this case may be prepared by mixing and optionally homogenizing the constituents identified above. It is preferably mixed and optionally homogenized in the mixing proportions with one another that have already been stated. In two-component or multicomponent systems, binder and crosslinking agent are combined within the processing life for application. In the case of spraying systems, there is no restriction of processing life, since mixing here is only performed immediately before application in the spraying procedure (cf. Römpp Lacke and Druckfarben, Georg Thieme Verlag Stuttgart/New York 1998, ISBN 3-13-776001-1, entry heading “two-component coating materials”). The basecoat material of the invention may be prepared using the mixing techniques and mixing assemblies that are customary and known for preparing basecoat materials.

Additionally provided for the present invention is the use of the basecoat material of the invention as a basecoat in a multicoat paint system. The multicoat paint system comprises at least one basecoat of a basecoat material of the invention, and at least one clearcoat.

The present invention further provides for the use of the basecoat material of the invention as a basecoat in a dual paint system. The dual paint system comprises at least one multicoat paint system composed of at least one basecoat of the basecoat material of the invention and of at least one clearcoat. The dual coating further comprises at least one additional basecoat of the basecoat material of the invention and at least one additional clearcoat, which are disposed over the overbaked multicoat paint system. Preferably the multicoat paint system is overbaked.

Additionally provided by the invention is a multicoat paint system as defined above. This system has at least one basecoat of the basecoat material of the invention, and at least one clearcoat.

Additionally provided by the invention is a dual paint system as defined above. The basecoat material of the invention is employed as basecoat both for producing the multicoat paint system stated above and for producing the additional basecoat. The multicoat paint system is preferably overbaked. In the case of overbaking, therefore, it is not necessary to provide a basecoat material with a different composition. Instead, the same basecoat material of the invention may be used both as basecoat material of the multicoat paint system and as additional basecoat.

The clearcoat materials of the multicoat paint system and of the additional clearcoat may be commercial clearcoat materials. For the clearcoat of the multicoat paint system and for the additional clearcoat it is preferred to use the same clearcoat materials.

The coating of the basecoat material of the invention is applied preferably in a dry film thickness of 4 to 35 μm. Preference is given to a dry film thickness of 6 to 30 μm, more preferably 6 to 25 μm.

The basecoat materials of the invention and also the further coating materials of the multicoat or dual paint system may be applied by the usual techniques such as spraying (e.g., airless, airmix, compressed air, hot spraying methods or induction mixing), rolling, roller coating, brushing or via a cartridge. The coating materials are preferably sprayed.

The present invention further provides a method for producing the multicoat paint system of the invention. This method involves successively applying at least one basecoat material of the invention and at least one clearcoat material. The clearcoat material may be applied wet-on-wet and cured.

Additionally provided for the present invention is a method for producing the dual paint system of the invention. This method involves successively applying at least one basecoat material of the invention, as additional basecoat, and at least one clearcoat material, as additional clearcoat, to the multicoat paint system of the invention. The coating material of the additional clearcoat may be applied wet-on-wet and cured.

The multicoat paint systems and dual paint systems may have been applied to any desired substrates. Here, the coat of the basecoat material of the invention acts as basecoat material of the multicoat paint system and as additional basecoat of a dual paint system. The substrates may be constructed of any of a very wide variety of materials and combinations of materials such as metallic and non-metallic materials. Preferably, metals and plastics, preferably automobile bodies or parts thereof, are coated.

The invention further provides for the use of the basecoat material of the invention to coat substrates, preferably the substrates identified above. These substrates also include coatings in the form of the multicoat paint system of the invention and of the dual paint system of the invention. The multicoat paint system is preferably overbaked.

Further provided by the invention are the above-stated substrates coated with the basecoat material of the invention and/or with the multicoat paint system of the invention and/or with the dual paint system of the invention.

The invention is illustrated below with reference to examples.

### EXAMPLES

### Preparation of a Silver Waterborne Basecoat Material 1

For better assessment of any paint defects that occur, a silver waterborne basecoat material was used, which was prepared in accordance with the following instructions:

### 1. Preparation of a Silver Waterborne Basecoat Material 1

The components listed in Table 1 under “aqueous phase” are stirred together in the stated order to form an aqueous mixture. In the next step, an organic mixture is prepared from the components listed under “organic phase”. The organic mixture is added to the aqueous mixture. The combined mixture is then stirred for 10 minutes and adjusted using deionized water and dimethylethanolamine to a pH of 8.0 and to spray viscosity.

TABLE 1

| Component | Parts by weight |
|---|---|
| Aqueous phase | |
| 3% strength Na Mg phyllosilicate solution | 22 |
| Deionized water | 7.3 |
| Polyurethane acrylate, prepared as per | 4.6 |
| Example D of DE-A-4437535 | |
| Tensid S (surfactant; BASF) | 0.9 |
| Polyester, prepared as per Example D of | 1 |
| DE-A-4009858 | |
| Butylglycol | 1.8 |
| Luwipal 052, melamine-formaldehyde resin, | 5 |
| available from BASF | |
| Tensid S (surfactant; BASF) | 0.7 |
| 10% strength dimethylethanolamine in water | 0.5 |
| Pluriol P 900, propylene oxide, available | 0.7 |
| from BASF | |
| Isopropanol | 3.3 |
| Deionized water | 2 |
| 3% strength by weight aqueous Viscalex HV | 3 |
| 30 solution, rheological agent available | |
| from BASF | |
| Deionized water | 2 |
| 20.5% strength by weight solution of DSX | 0.4 |
| 1550 (Cognis) rheological agent | |
| Deionized water | 2 |
| Polyurethane acrylate, prepared as per | 15.8 |
| Example 2 of DE-A-19948004 | |
| Deionized water | 1 |
| 10% strength dimethylethanolamine in water | 0.4 |
| Tensid S (surfactant; BASF) | 0.5 |
| Deionized water | 4 |
| Isopar L, solvent, available from Exxon Mobil | 0.9 |
| Propanol | 0.9 |
| Deionized water | 3.7 |
| Organic phase | |
| Commercial aluminum pigment available from | 5.2 |
| Altana-Eckart | |
| Butylglycol | 8.4 |
| Polyester, prepared as per Example D of | 5 |
| DE-A-4009858 | |

### 2. Preparation of the Inventive Waterborne Basecoat Material and of the Comparative Coating Materials as Additional Basecoat Materials in a Dual Paint System.

For the preparation of the inventive basecoat material 2 and of the comparative coating materials 3 to 7, the waterborne basecoat material 1 is admixed with 0.3 part by weight of the solids of a further constituent, based on the total weight of the waterborne basecoat material 1.

TABLE 2

| | | Weight fraction |
|---|---|---|
| | | relative to |
| Waterborne | | the total weight |
| basecoat | | of the waterborne |
| material | Further constituent | basecoat material 1 |
| 1 | No further constituents | 0 |
| 2 | Dowfax ® 2A1 (available from | 0.7 |
| | Dow) alkyldiphenyl oxide | |
| | disulfonate | |
| 3 | Disponil FES77 (available | 1 |
| | from Cognis) fatty alcohol | |
| | polyglycol ether sulfate, Na | |
| | salt | |
| 4 | Lutensol AT 18 (available | 1.5 |
| | from BASF) alkylpolyethylene | |
| | glycol ether | |
| 5 | Lumiten I-RA (available from | 0.6 |
| | BASF) 2-sulfosuccinic ester | |
| | derivative | |
| 6 | Starfactant 20 (available | 0.5 |
| | from Cognis) nonionic alkyd | |
| | resin | |
| 7 | Nacure 3525 (available from | 0.85 |
| | King Industries) | |
| | Dinonylnaphthalenedisulfonic | |
| | acid, amine salt | |

Coating materials 1-7 were tested for their adhesion properties. For this purpose, they were applied as an “overbaked dual paint system”.

### Dual Paint System

A metal panel with dimensions of 10×20 cm that bore a primer-surfacer coat of a commercial primer-surfacer was the substrate used. In the production of this substrate, the primer-surfacer was dried at 80° C. for a period of 10 minutes and then baked at 190° C. for a period of 30 minutes.

First of all, the respective basecoat material as per Table 2 was applied pneumatically to this metal panel. After one minute of flashing of the basecoat material at room temperature, the basecoat was dried in a forced-air oven at 70° C. for 10 minutes. Then the two-component clearcoat material FF98-0018, available commercially from BASF, was applied, likewise pneumatically, and, after 20 minutes' flashing at room temperature, the two films were baked at a temperature of 160° C. over a period of 30 minutes. The result was an overbaked multicoat paint system.

After the overbaked multicoat paint system had cooled, application, flashing, drying, and baking of the coating materials were repeated, using in each case the same basecoat materials as per Table 2 as additional basecoat materials, and the above-identified clearcoat material as additional clearcoat material. After that, the adhesion of the additional basecoat materials 1 to 7 to the overbaked clearcoat films was investigated.

The stone chipping test was carried out in accordance with DIN 55966-1. The results of the stone chipping test were assessed in accordance with DIN EN ISO 20567-1.

The steam jet test was carried out in accordance with DIN 55662. The results of the steam jet test were assessed in accordance with DIN EN ISO 55662.

The cross-cut test was carried out in accordance with DIN 2409. The results of the cross-cut test were assessed in accordance with DIN EN ISO 2409.

Table 3 shows the results and the specification-related assessment of the adhesion tests on each of the paint systems.

TABLE 3

| Basecoat | Stonechip | Steam jet | Cross-cut |
|---|---|---|---|
| material | result | result | result |
| 1 | 3 (unsat.) | sat. | Total delamination |
| | | | (unsat.) |
| 2 | 1.5 (sat.) | sat. | 0 (sat.) |
| 3 | 2.5 (unsat.) | sat. | 4 (unsat.) |
| 4 | 3 (unsat.) | sat. | 5 (unsat.) |
| 5 | 2 (unsat.) | sat. | 2 (unsat.) |
| 6 | 3 (unsat.) | sat. | Total delamination |
| | | | (unsat.) |
| 7 | 3 (unsat.) | sat. | 5 (unsat.) |

sat. = satisfactory
unsat. = unsatisfactory

On the basis of the results of the stone chipping test and cross-cut test, basecoat materials 1 and 3 to 7 exhibited inadequate adhesion to the underlying overbaked clearcoat. Only basecoat material 2, containing disulfonates, gave good adhesion.

1. A thermally curable basecoat material comprising
a. at least one polyurethane resin as binder,
b. at least one pigment,
c. 30% to 70% by weight of water, based on the total weight of the basecoat material, and
d. 0.04% to 2.3% by weight, based on the total weight of the basecoat material, of at least one compound of the formula (I) 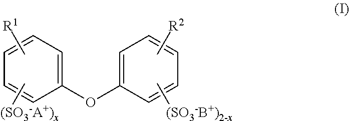
in which
R¹ and R² are hydrogen atoms or linear or branched alkyl radicals having 4 to 24 carbon atoms, where R¹ and R² can be identical or different,
A and B independently of one another are H, an alkali metal or NH₄, and
x is 1 or 2.

2. The basecoat material of claim 1, wherein the compound of formula (I) is present in an amount of 0.04% to 1.60% by weight, based on the total weight of the basecoat material.

3. The basecoat material of claim 1, wherein the compound of formula (I) is present in an amount of 0.04% to 1.20% by weight, based on the total weight of the basecoat material.

4. The basecoat material of claim 1, wherein at least one of the radicals R¹ or R² is an alkyl radical.

5. The basecoat material of claim 1, wherein precisely one of radical R¹ or R², is an alkyl radical.

6. A process for preparing the basecoat material of claim 1, which comprises mixing and optionally homogenizing its constituents.

7. A multicoat paint system comprising at least one basecoat and at least one clearcoat, the at least one basecoat comprising the basecoat material of claim 1.

8. A dual paint system comprising the multicoat paint system of claim 7 and also at least one additional basecoat of the basecoat material of claim 1 and at least one additional clearcoat, which are disposed above the multicoat paint system of claim 7.

9. A method of coating a substrate with a multicoat paint system, comprising applying to a substrate the multicoat paint system of claim 7.

10. A method for producing a multicoat paint system of claim 7, which comprises successively applying at least one basecoat material of claim 1 and at least one clearcoat material.

11. A method of coating a substrate with a dual paint system, comprising applying to a substrate the multicoat paint system of claim 7 and also, over said multicoat paint system, applying at least one additional basecoat of the basecoat material of claim 1 and at least one additional clearcoat, such that the additional basecoat material and clearcoat are disposed above the multicoat paint system.

12. The dual paint system of claim 8, wherein the same clearcoat material is used for the clearcoat of the multicoat paint system and for the at least one additional clearcoat.

13. A method for producing a dual paint system of claim, which comprises successively applying at least one basecoat material of claim 1 as an additional basecoat and at least one clearcoat material as additional clearcoat to a multicoat paint system of claim 7.

14. A method of coating a substrate comprising applying the basecoat material of claim 1 a substrate.

15. The coated substrate of claim 14.
